(19) United States
(12) Patent Application Publication
(10) Pub. No.: US 2011/0217462 A1
(43) Pub. Date: Sep. 8, 2011

(54) METHODS FOR MANUFACTURING INSULATED HEAT CONDUCTIVE SUBSTRATE AND INSULATED HEAT CONDUCTIVE COMPOSITE SUBSTRATE

(75) Inventors: DAVID SHAU CHEW WANG, TAIPEI CITY (TW); YI AN SHA, TAIPEI COUNTY (TW); KUO HSUN CHEN, MIAOLI COUNTY (TW)

(73) Assignee: POLYTRONICS TECHNOLOGY CORP., HSINCHU (TW)

(21) Appl. No.: 13/106,596

(22) Filed: May 12, 2011

Related U.S. Application Data
(63) Continuation-in-part of application No. 11/699,710, filed on Jan. 30, 2007.

(30) Foreign Application Priority Data
Sep. 26, 2006 (TW) 095135494

(51) Int. Cl. B05D 5/00

(52) U.S. Cl. 427/209

(57) ABSTRACT

A method for manufacturing an insulated heat conductive substrate comprises the steps of: performing hydrolysis and condensation of at least one thermally conductive ceramic powder to prepare at least one modified thermally conductive ceramic powder, which comprises a plurality of modified powder particles, each grafted with an organic material; mixing the at least one modified thermally conductive ceramic powder with two substantially mutually soluble polymers to achieve a uniform mixture; blending the uniform mixture with a curing agent to obtain a melt extrudable dielectric curable material; extruding the dielectric curable material through a slit to form a sheet-like substrate; and disposing a first film and a second film on two side surfaces of the substrate to obtain an insulated heat conductive substrate, wherein each of the first and second films can be either a metal foil or a release film.

### CROSS REFERENCE TO RELATED APPLICATIONS

This application is a continuation in part of Ser. No. 11/699,710, filed Jan. 30, 2007, which claims the priority benefit of Taiwan patent application serial no. 095135494 filed on Sep. 26, 2006.

### BACKGROUND OF THE INVENTION

1. Field of the Invention

The present invention relates to a method for manufacturing a heat conductive substrate, and relates more particularly to methods for manufacturing an insulated heat conductive substrate and an insulated heat conductive composite substrate.

2. Description of the Related Art

Because printed circuit boards of electronic devices are now using electronic components with higher power levels than ever before, the management of heat from the electronic components can no longer be ignored. If heat from the electronic components cannot efficiently dissipate, the electronic components may operate at elevated temperatures. Overly high temperature may lower the operating efficiency of the electronic components, further affecting their lifespan and reliability. Therefore, printed circuit boards with better heat dissipation capability are required for electronic devices to facilitate heat dissipation of the electronic components.

A traditional heat conductive printed circuit board can be manufactured by mixing liquid epoxy resin, heat conductive fillers and a curing agent to form a slurry, which is then coated on metal foil and heated to cure to B-stage before being hot pressed to form printed circuit boards. Alternatively, a traditional heat conductive printed circuit board can also be manufactured by coating liquid epoxy resin on a glass fiber cloth and curing the epoxy resin to B-stage, before a plurality of epoxy resin coated glass fiber cloths are hot pressed to form printed circuit boards.

The above-mentioned conventional methods need low-viscosity slurry; however, the solid portion and the liquid portion may easily separate in low-viscosity slurry, causing non-uniform mixing issue affecting heat dissipation efficiency. Furthermore, the slurry cannot be easily stored. In addition, due to low thermal conductivity of glass fiber (about 0.36 W/mK), the printed circuit board made of glass fiber has poor heat dissipation. Moreover, the above-mentioned conventional methods need a coating process, which is slow and results in a low yield.

In summary, convention methods for manufacturing heat conductive printed circuit boards include a coating process, which is slow and results in a low yield, and need low-viscosity slurry having a solid-liquid separation issue. In addition, due to low thermal conductivity of glass fiber, the printed circuit board made of glass fiber has poor heat dissipation. Thus, a new method suitable for mass production that can produce an insulated heat conductive substrate having high heat dissipation capability is required.

### SUMMARY OF THE INVENTION

The invention provides an insulated heat conductive substrate and methods for manufacturing an insulated heat conductive substrate and an insulated heat conductive composite substrate. The insulated heat conductive substrate is made of dielectric curable material having an interpenetrating structure and appearance similar to rubber. The dielectric curable material has high thermal conductivity, and has no solid-liquid separation issue, and can be processed using an extrusion process. Therefore, the manufacturing speed can be increased.

According to one aspect of the present invention, a method for manufacturing an insulated heat conductive substrate comprises the steps of: performing hydrolysis and condensation of at least one thermally conductive ceramic powder to prepare at least one modified thermally conductive ceramic powder with thermal conductivity greater than 20 W/mK, wherein the at least one modified thermally conductive ceramic powder comprises a plurality of modified powder particles each grafted with an organic material; mixing the at least one modified thermally conductive ceramic powder with two mutually soluble polymers at a temperature of 50° C. to 150° C. above the highest glass transition temperature of the polymers to obtain a uniform mixture, wherein the two polymers include thermoplastic polymer and thermoset epoxy resin, and the mixture comprises 50% to 75% by volume of the thermally conductive powder; blending the uniform mixture with a curing agent at a temperature below 120° C. to obtain a melt extrudable dielectric curable material; extruding the dielectric curable material at a temperature between 50° C. and 120° C. through a slit to form a sheet-like substrate; blending the uniform mixture with a curing agent at a temperature below 120° C. to obtain a melt extrudable dielectric curable material; and disposing separately a first film and a second film on two opposite side surfaces of the substrate to obtain an insulated heat conductive substrate, wherein each of the first and second films can be a metal foil or a release film.

According to another aspect of the present invention, a method for manufacturing an insulated heat conductive composite substrate comprises the steps of: performing hydrolysis and condensation of at least one thermally conductive ceramic powder to prepare at least one modified thermally conductive ceramic powder with thermal conductivity greater than 20 W/mK, which comprises a plurality of modified powder particles, each grafted with an organic material; mixing the at least one modified thermally conductive ceramic powder with two substantially mutually soluble polymers at a temperature of 50° C. to 150° C. above the highest glass transition temperature of the polymers to achieve a uniform mixture, wherein the two polymers include thermoplastic polymer and thermoset epoxy resin, and the mixture comprises 50% to 75% by volume of the thermally conductive powder; blending the uniform mixture with a curing agent at a temperature below 120° C. to obtain a melt extrudable dielectric curable material; extruding the dielectric curable material through a slit at a temperature between 50° C. and 120° C. to form a curable sheet-like substrate; disposing separately a first film and a second film on two side surfaces of the substrate to form a stacked first film, second film and substrate, wherein each of the first and second films can be a metal foil or a release film; cutting a combination of the substrate, the first film, and the second film to obtain an insulated heat conductive substrate; and pressing a plurality of the insulated heat conductive substrates at an elevated temperature ranging from 130° C. to 250° C. to obtain a cross-linked insulated heat conductive composite substrate.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 is a flow chart describing a method for manufacturing an insulated heat conductive composite substrate according to one embodiment of the present invention;

FIGS. 2A to 2C are cross-sectional views showing insulated heat conductive composite substrates according to one embodiment of the present invention; and

FIG. 3 is a view showing a continuous ejection molding apparatus according to one embodiment of the present invention.

### DETAILED DESCRIPTION OF THE INVENTION

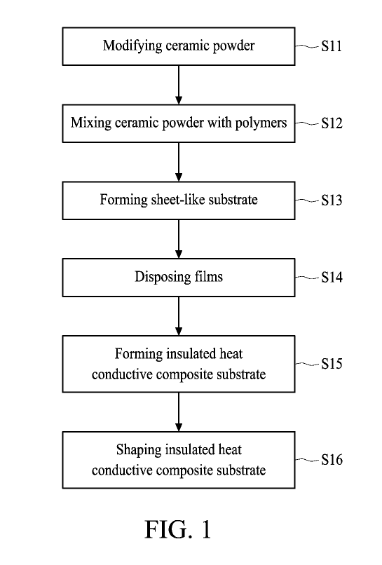

FIG. 1 is a flow chart describing a method for manufacturing an insulated heat conductive composite substrate according to one embodiment of the present invention. In Step S11, at least one modified thermally conductive ceramic powder with thermal conductivity above 20 W/mK is obtained by hydrolysis and condensation of at least one thermally conductive ceramic powder, wherein the at least one modified ceramic powder comprises a plurality of modified powder particles, each grafted with an organic material. The thermal conductive ceramic powder is nitride, oxide, or a mixture thereof. In one embodiment, the organic material comprises organic silicon such as silane, and the hydrolysis and condensation reaction is performed by reacting the organic silicon with the at least one thermally conductive ceramic powder in an acidic environment. In another embodiment, the organic material comprises organic titanium, and the hydrolysis and condensation is performed by reacting the organic titanium with the at least one thermally conductive ceramic powder in an acidic environment. The acidic environment in the above-mentioned two embodiments can have pH levels between pH 1 and pH 5. In Step S12, the at least one modified thermally conductive ceramic powder and two substantially mutually soluble polymers are mixed to achieve a uniform mixture. The uniform mixture is then blended with a curing agent at a temperature below 120° C. to obtain a melt extrudable dielectric curable material, wherein the thermal conductivity of the dielectric curable material is greater than 1.0 W/mK. Specifically, the two substantially mutually soluble polymers may comprise a thermoplastic polymer and a thermoset polymer. The mixing temperature of the uniform mixture is 50° C. to 150° C. above the highest glass transition temperature of the polymers. The uniform mixture may contain 50% to 75% by volume of the thermal conductive filler. The low mixing temperature is adopted mainly to prevent the curing agent from activating and causing crosslinking of the thermoset polymer. The dielectric curable material is a paste like or a solid like material at room temperature. It can be softened and it can become melt extrudable material at elevated temperature. In Step S13, the dielectric curable material is extruded through a slit to form a sheet-like substrate, wherein the dielectric curable material is extruded through the slit at a temperature between 50° C. and 150° C. , preferably between 50° C. and 120° C.

In Step S14, a first film and a second film are separately disposed on two side surfaces of the substrate. The first and second films can individually be a metal foil or a release film. The first film, the substrate, and the second film (first film/substrate/second film) can be alternatively arranged in different combinations such as in a release-film/substrate/release-film combination (i.e., a prepreg substrate), a metal-foil/substrate/release-film combination (i.e., a resin coated metal substrate), and a metal-foil/substrate/metal-foil combination (i.e., a metal core substrate). In Step S15, insulated heat conductive substrates can be obtained by cutting the combined first film, substrate, and second film, and the insulated heat conductive substrate and metal substrate or printed circuit board can be stacked to form a single sided board, a double-sided board, a metal core board, or a multilayer board, which can be pressed at a pressing temperature to form a crosslinked insulated heat conductive composite substrate, wherein the pressing temperature can be between 130 degrees Celsius and 250 degrees Celsius. In Step S16, the insulated heat conductive composite substrate can be shaped using a contouring process, which may comprise a trimming process, a cutting process, a punching process, or a diamond cutting process.

The two substantially mutually soluble polymers may comprise thermoplastic polymer and thermosetting epoxy resin, and the amount of the thermosetting epoxy resin can be in a range of from 50 percent to 97 percent by total volume of polymers. The thermosetting epoxy resin can be cured by a curing agent at a temperature above 80 degrees Celsius.

In particular, the method for obtaining a dielectric curable material initially stirs the polymer containing thermoplastic polymer and thermosetting epoxy resin at 200 degrees Celsius for about 30 minutes to obtain a uniform mixture. The mixture is then uniformly mixed with modified thermally conductive ceramic powder to obtain a uniform rubber-like material. Finally, an accelerator and a curing agent are blended into the rubber-like material to form a dielectric curable material. Because the rubber-like material has an interpenetrating network structure, and the thermoplastic polymer and the thermosetting epoxy resin are mutually soluble and homogeneously mixed, the thermally conductive ceramic powder can be uniformly distributed in the interpenetrating network, resulting in preferred heat conductive capability. The thermally conductive ceramic powders are uniformly distributed in the polymer in an amount of 40 to 70 percent by volume based on the total volume of the polymer.

The thermally conductive ceramic powder is nitride, oxide, or a mixture thereof. The oxide can be selected from the group consisting essentially of aluminum oxide, magnesium oxide, zinc oxide, and beryllium oxide. The nitride can be selected from the group consisting essentially of zirconium nitride, boron nitride, aluminum nitride, and silicon nitride.

The above-mentioned thermoplastic polymer comprises ultra-high molecular phenoxy resin, wherein the ultra-high molecular phenoxy resin may have a molecular weight of greater than 30000. The thermoplastic polymer may include hydroxy phenoxy ether polymer, wherein diepoxide is polymerized with difunctional species to yield the hydroxy phenoxy ether polymer. The thermoplastic polymer can be yielded by reacting the liquid epoxy resin with the bisphenol A; the thermoplastic polymer can be yielded by liquid epoxy resin with a divalent acid; or the thermoplastic polymer can be yielded by reacting the liquid epoxy resin with amines. The above-mentioned thermosetting epoxy may be an uncured liquid epoxy resin, a polymerized epoxy resin, a phenolic epoxy resin or a bisphenol A epoxy resin.

The dielectric curable material including a thermoplastic polymer can be processed as a thermoplastic polymer because it has the characteristics of a thermoplastic polymer, and the dielectric curable material includes a thermosetting polymer so that it can be formed to have a cross-linked structure at high temperature. Therefore, the thermoplastic polymer and the thermosetting polymer can be interpenetrated into each other to form an interpenetrating network structure. Such a structure can have the characteristics of a thermosetting polymer that can endure high temperature without being deformed, and can have tenacious, non-brittle characteristics similar to those of a thermoplastic polymer, and can easily and strongly adhere to a metal electrode or a substrate.

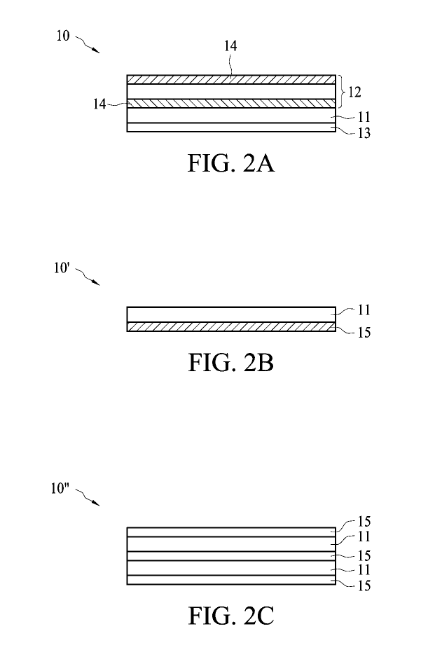

Referring to FIG. 2A, on the two side surfaces of the insulated heat conductive substrate 11, one side surface can be disposed with a printed circuit board 12, and another side surface can be disposed with a metal foil 12 with a thickness of 1.0 to 1.5 millimeters. The stacked substrate can be hot pressed at a temperature of 200 degrees Celsius and a pressure of 25 kg/cm² to form an insulated heat conductive composite substrate 10. In one embodiment, the metal foil can be an aluminum foil. The pressed insulated heat conductive composite substrate 10 is a single-sided, double aluminum layered board, wherein at least one surface of the printed circuit board 12 can be a patterned metal layer 14. Referring to FIG. 2B, one side surface of the insulated heat conductive substrate 11 can be attached with a metal foil 15, and another side surface of the insulated heat conductive substrate 11 can be disposed with a metal foil 15. The stacked metal foil 15/insulated heat conductive substrate 11/metal foil 16 combination is hot pressed at 200 degrees Celsius for 90 minutes (for controlling the thickness, for example 0.5 millimeter, thereof) to form another embodiment of an insulated heat conductive composite substrate 10′, namely a single-sided metal substrate. The metal foil 15, the metal foil 16, and the insulated heat conductive substrate 11 are joined physically, and the conductivity of the formed composite is greater than 1.0 W/mK. The insulated heat conductive composite substrate 10′ can have a thickness of less than 0.5 millimeter and can endure a voltage of greater than 1000 volts.

Referring to FIG. 2C, the insulated heat conductive substrate 11 can be layered with metal foils 15 of different material, and the layered metal foil 15/insulated heat conductive substrate 11/metal foil 15/insulated heat conductive substrate 11/metal foil 15 combination can be hot pressed to form a structure of a metal core board.

During a hot pressing process, the sheet-like heat conductive substrate does not have the solid-liquid separation issue due to the cross-linking structure thereof. The material of the metal foil 15 can be a metal selected from the group consisting of copper, aluminum, nickel, copper alloy, aluminum alloy, nickel alloy, copper nickel alloy, and copper aluminum alloy. The sheet-like heat conductive substrate appears more like rubber than slurry, and therefore it can be conveniently stored and easily processed. In addition, the heat conductive substrate can be processed like a thermoplastic polymer, exhibiting excellent manufacturability.

In the polymer, the thermoplastic polymer and the thermosetting epoxy resin are substantially mutually soluble. The term “substantially mutually soluble” means that the thermoplastic polymer and the thermosetting epoxy resin are mixed to form a mixture having a single glass transition temperature. The thermoplastic polymer and the thermosetting epoxy resin are mutually soluble. Thus, when both are mixed, the thermoplastic polymer is dissolved into the thermosetting epoxy resin so that the glass transition temperature of the thermoplastic polymer is substantially reduced. The mixing process can be conducted at a temperature lower than the normal softening temperature of the thermoplastic polymer. The formed mixture (i.e., the polymer component) is rubbery (or solid) at room temperature and thus it can be easily weighed and stored. For example, although the thermosetting epoxy resin is a liquid epoxy resin, the mixture of the thermosetting epoxy resin and the thermoplastic polymer can appear more like a tough leathery film than like liquid. At temperatures below 25 degrees Celsius, the mixture can have a relatively high viscosity coefficient (about 10⁵ to 10⁷ poise), sufficient to prevent fillers from settling or redistribution in the polymer. Moreover, at a general mixing temperature (about 40 to 100 degrees Celsius) the mixture has a sufficiently low viscosity coefficient (about 10⁴ to 10⁵ poise) to allow added curing agent and ceramic powder to be uniformly distributed and reacted in the mixture. Many exemplary mixtures can be found in PCT Patent Publication No. WO92/08073 (published on 14 May 1992) incorporated herein by reference.

The curing agent used to cure (i.e., cross link or catalytic-polymerize) the thermosetting epoxy resin in the dielectric curable material can have a curing temperature T_{cure} of higher than 100 degrees Celsius. The curing agent is used to quickly cure the thermosetting epoxy resin at a temperature higher than the mixing temperature Tₘᵢₓ, wherein the mixing temperature Tₘᵢₓ herein means a temperature at which the thermoplastic polymer, the thermosetting epoxy resin, and the curing agent are mixed. The mixing temperature Tₘᵢₓ can usually be about 25 to 100 degrees Celsius. When a curing agent is added at the mixing temperature Tₘᵢₓ, the curing reaction is negligible. The amount of the curing agent added in the present invention can cause the thermosetting epoxy resin to be cured at a temperature higher than the mixing temperature Tₘᵢₓ. Preferably, the curing agent will not start a substantial curing reaction at a temperature of lower than about 100 degrees Celsius. Accordingly, the dielectric curable material can remain substantially uncured at 25 degrees Celsius for at least half a year.

In addition to the above-mentioned materials, the thermoplastic polymer in the dielectric curable material can be selected from the substantially amorphous thermoplastic resin, and the definition of the resin can be found with reference to Page 1 of “Saechtling International Plastic Handbook for the Technology, Engineer and User, Second Edition, 1987, Hanser Publishers, Munich.” The term “substantially amorphous” means that the proportion of the part of “crystallinity” in the resin is at most 15 percent, and preferably 10 percent, and especially preferably 5 percent, for example, a crystallinity of 0 percent to 5 percent. The substantially amorphous thermoplastic resin is a high-molecular polymer, which is rigid or rubbery at room temperature, and the above polymer component is used for providing the properties of strength and high viscosity when it is substantially uncured. The substantially amorphous thermoplastic resin usually can be in an amount of 10 percent to 75 percent by volume based on total polymer volume, preferably 15 percent to 60 percent, and especially preferably 25 percent to 45 percent of the polymer. The substantially amorphous thermoplastic resin can be selected from the group consisting essentially of polysulfone, polyethersulfone, polystyrene, polyphenylene oxide, polyphenylene sulfide, polyamide, phenoxy resin, polyimide, polyetherimide, polyetherimide/silicone block copolymer, polyurethane, polyester, polycarbonate, and acrylic resin (e.g., polymethyl methacrylate, styrene/Acrylonitrile, and styrene block copolymers).

Moreover, the thermoplastic polymer preferably includes a hydroxy-phenoxyether polymer structure. The hydroxy-phenoxyether is formed by a polymerization reaction of the stoichiometric mixture including diepoxide and difunctional species. The diepoxide is an epoxy resin with an epoxy equivalent weight of about 100 to 10000. For example, diglycidyl ether of bisphenol A, diglycidyl ether of 4,4′-sulfonylbisphenol, diglycidyl ether of 4,4′-oxybisphenol, diglycidyl ether of 4,4′-dihydroxybenzophenone, diglycidyl ether of hydroquinone, and diglycidyl ether of 9,9-(4-hydroxyphenyl) fluorine. The difunctional species is dihydric phenol, dicarboxylic acid, primary amine, dithiol, disulfonamide, or bis-secondary amine. The dihydric phenol is selected from the group consisting essentially of 4,4′-isopropylidene bisphenol (bisphenol A), 4,4′-sulfonylbisphenol, 4,4′-oxybisphenol, 4,4′-dihydroxybenzophenone, and 9,9-bis(-hydroxyphenyl) carbazole. The dicarboxylic acid is selected from the group consisting essentially of isophthalic acid, terephthalamic acid, 4,4′-biphenylenedicarboxylic acid, and 2,6-naphthalenedicarboxylic acid. The bis-secondary amine is selected from the group consisting essentially of piperazine, dimethyl piperazine, and 1,2-bis(N-aminomethyl) ethane. The primary amine is selected from the group consisting essentially of 4-methoxyaniline and 2-aminoethanol. The dithiol is 4,4′-dimercaptodiphenyl ether. The disulfonamide is selected from the group consisting essentially of N,N′-dimethyl-1,3-benzenedisulfonamide, and N,N′-bis(2-hydroxyethyl)-4,4-biphenyldisulfonamide. Moreover, the difunctional species also includes a mixture comprising two different functional groups for reaction with the epoxide group, for example, salicylic acid and 4-hydroxybenzoic acid.

The thermoplastic polymer in the dielectric curable material of the present invention can be a reaction product of liquid epoxy resin with bisphenol A, bisphenol F, or bisphenol S, a reaction product of liquid epoxy resin with a divalent acid, or a reaction product of liquid epoxy resin with amines.

In addition, the thermosetting epoxy resin in the dielectric curable material of the present invention also can be selected from the thermosetting epoxy resin defined in “Saechtling International Plastic Handbook for the Technology, Engineer and User, 2nd (1987), pp. 1-2, Hanser Publishers, Munich.” The polymer usually comprises 25% to 90%, preferably 40% to 85%, and especially preferably 55% to 75% of the thermosetting epoxy resin by volume. The volume ratio of the substantially amorphous thermoplastic resin to the thermosetting epoxy resin in the polymer ranges from about 1:9 to 3:1. The thermosetting epoxy resin preferably has a functionality of larger than 2. At room temperature, the thermosetting epoxy resin is liquid or solid. If it is cured without adding any thermoplastic resin, the thermosetting epoxy resin is rigid or rubbery. The thermosetting epoxy resin is preferably uncured epoxy resin, and especially uncured epoxy resin defined by ASTM D 1763. The liquid epoxy resin can be further understood with reference to the description in “Engineered Materials Handbook, Engineering Plastics, Volume 2, and pp. 204-241. Publisher: ASM International Page 240-241.” The term “epoxy resin” refers to a conventional dimeric epoxy resin, an oligomeric epoxy resin, or a polymeric resin. The epoxy resin is a reaction product of bisphenol A with epichlorohydrin, a reaction product (novolac resin) of phenol with formaldehyde, a reaction product of epichlorohydrin, cycloaliphatics, peracid epoxy resin with glyceryl ether, a reaction product of epichlorohydrin with p-amino phenol, a reaction product of epichlorohydrin with glyoxal tetraphenol, phenolic epoxy resin or bisphenol A epoxy resin. Commercially available epoxide is preferably 3,4-epoxycyclohexylmethyl 3,4-epoxycyclohexane formate (e.g., ERL 4221 of Union Carbide Company or CY-179 of Ciba Geigy Company) or bis(3,4-epoxycyclohexylmethyl) adipate (e.g., ERL 4299 of the Union Carbide Company). Commercially available diglycidyl ether of bisphenol A (DGEBA) is selected from Araldite 6010 of Ciba Geigy Company, DER 331 of Dow Chemical Company, and Epon 825, 828, 826, 830, 834, 836, 1001, 1004, or 1007 of Shell Chemical Company. Moreover, the polyepoxidized phenol formaldehyde novolac prepolymer is selected form DEN 431 or 438 of Dow Chemical Company and CY-281 of Ciba Geigy Company. The polyepoxidized cersol formaldehyde novolac prepolymer is selected from ENC 1285, 1280, or 1299 of Ciba Geigy Company. The poly polyol glycidyl ether is selected from Araldite RD-2 (based on butyl-1,4-diol) of the Ciba Geigy Company or Epon 812 (based on glycerol) of Shell Chemical Company. A suitable diepoxide of alkyl cycloalkylhydrocarbon is vinyl cyclohexane dioxide, e.g., ERL 4206 of Union Carbide Company. Moreover, a suitable diepoxide of cycloalkyl ether is bis(2,3-diepoxycyclopentyl)-ether, e.g., ERL 0400 of Union Carbide Company. Moreover, the commercially available flexible epoxy resin includes polyglycol diepoxy (e.g., DER 732 and 736 of the Dow Chemical Company), diglycidyl ether of linoleic dimmer acid (e.g., Epon 871 and 872 of Shell Chemical Company), and diglycidyl ether of bisphenol, wherein the aromatic ring is connected by a long aliphatic chain (e.g., Lekutherm X-80 of the Mobay Chemical Company).

Moreover, the thermosetting epoxy resin having multiple functional groups is selected from DEN 4875 (namely, a solid novolac resin) of Dow Chemical Company, Epon 1031 (tetra-functional solid epoxy resin) of Shell Chemical Company and Araldite MY 720 (N,N,N′,N′-tetraglycidyl-4,4′-methylene dianiline) of Ciba-Geigy Company. Moreover, the difunctional epoxy resin (dicyclic oxide) is selected from HPT 1071 (solid resin, N,N,N′,N′-tetraglycidyl-a,a′-bis(4-aminophenyl) P-Di-Isopropylbenzene), HPT 1079 of Shell Chemical Company (solid diglycidyl ether of bisphenol-9-carbazole) or Araldite 0500/0510 (tridiglycidyl ether of p-aminophenol) of Ciba-Geigy Company.

The curing agent used in the present invention is selected from isophthaloyl dihydrazide, benzophenone tetracarboxylic dianhydride, diethyltoluene diamine, 3,5 -dimethylthio-2,4-toluene diamine, dicyandiamide (obtained from Curazol 2PHZ of the American Cyanamid Company) or DDS (diaminodiphenyl sulfone, obtained from Calcure of Ciba-Geigy Company). The curing agent is selected from the substituted dicyandiamide (e.g., 2,6-xylylbiguanide), solid polyamide (e.g., HT-939 of Ciba-Geigy Company or Ancamine 2014AS of Pacific Anchor Company), solid aromatic amine (e.g., HPT 1061 and 1062 of Shell Chemical Company), solid anhydride hardener (e.g., pyromellitic dianhydride (PMDA)), phenolic resin hardener (e.g., poly(p-hydroxy styrene), imidazole, the adduct of 2-phenyl-2,4-dihydroxymethylimizole and 2,4-diamino-6[2′-methylimizole(1)]ethyl-s-triazinylisocyanate), boron trifluoride, and amine complex (e.g., Anchor 1222 and 1907 of Pacific Anchor Company), and trimethylol propane triacrylate.

As for the thermosetting epoxy resin, the curing agent is preferably dicyandiamide and is used together with an accelerating agent. The commonly used accelerator for curing includes urea or urea compounds, for example, 3-phenyl-1,1-dimethylurea, 3-(4-chlorophenyl)-1,1-dimethylurea, 3-(3,4-dichlorophenyl)-1,1-dimethylurea, 3-(3-chloro-4-methylphenyl)-1,1-dimethylurea and imidazole (e.g., 2-heptadecylimidazole, 1-cyanoethyl-2-phenylimidazole-trimellitate, or 2-[β-{2′-methylimidazol-(1′)}]-ethyl-4,6-diamino-s-triazinyl).

If the thermosetting epoxy resin is urethane, then the curing agent can use blocked isocyanate, (e.g., alkyl phenol blocked isocyanate selected from Desmocap 11A of Mobay Corporation) or phenol blocked polyisocyanate adduct (e.g., Mondur S of Mobay Corporation). If the thermosetting epoxy resin is unsaturated polyester resin, then the curing agent can use peroxide or other free radical catalysts, such as dicumyl peroxide, 2,5-dimethyl-2,5-di(t-butylperoxy)hexane, t-butyl cumyl peroxide, and 2,5-dimethyl-2,5-di(t-butylperoxy)-3-hexyne. Moreover, the unsaturated polyester resin is crosslinked through radiation (e.g., an ultraviolet radiation, a high-power electron beam, or γ radiation).

Some thermosetting epoxy resin can be cured without using a curing agent. For example, if the thermosetting epoxy resin is a bismaleimide (BMI), the BMI are crosslinked at a high temperature, and a co-curing agent (e.g., O,O′-diallyl bisphenol A) may be added together to make the cured BMI tougher.

The above-mentioned resin cross-linked using a peroxide crosslinker, high-power electron beam, or γ radiation is preferably added with an unsaturated cross-linking agent, e.g., triallyl isocyanurate (TAIC), triallyl cyanurate (TAC) or TMPTA.

The above-mentioned thermally conductive ceramic powder can be selected from a nitride, an oxide and mixture thereof. The nitride can be selected from the group consisting essentially of zirconium nitride, boron nitride, aluminum nitride, and silicon nitride. The oxide can be selected from the group consisting essentially of aluminum oxide, magnesium oxide, zinc oxide, and titanium dioxide.

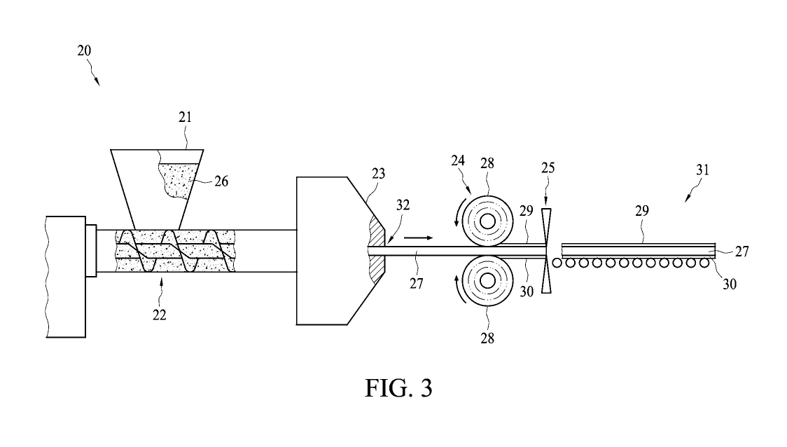

FIG. 3 is a view showing a continuous ejection molding apparatus 20 according to one embodiment of the present invention. The continuous ejection molding apparatus 20 comprises a feeding mechanism 21, a delivery mechanism 22, a die head 23 having a slit 32, a pressing roller device 24, and a cutting device 25. The feeding mechanism 21 is configured for provision of dielectric curable material 26. The delivery mechanism 22 is configured to extrude the dielectric curable material through the slit 32 of the die head 23 to form a sheet-like substrate 27, wherein the dielectric curable material 26 is extruded through the slit 32 at a temperature in a range of from 50 degrees Celsius to 150 degrees Celsius. The pressing roller device 24 comprises steel rollers 28, and a first film 29 and a second film 30 separately wind the rollers 28. When the sheet-like substrate 27 is moved through the rollers 28, the first film 29 and the second film 30 are separately pressed on the two opposite side surfaces of the sheet-like substrate 27. The cutting device 25 is configured to cut the substrate 27 into insulated heat conductive substrate 31.

The above-described embodiments of the present invention are intended to be illustrative only. Numerous alternative embodiments may be devised by persons skilled in the art without departing from the scope of the following claims.

What is claimed is:

1. A method for manufacturing a sheet-like insulated heat conductive substrate, comprising steps of:
performing hydrolysis and condensation of at least one thermally conductive ceramic powder to prepare at least one modified thermally conductive ceramic powder with thermal conductivity greater than 20 W/mK, which comprises a plurality of modified powder particles, each grafted with an organic material;
mixing the at least one modified thermally conductive ceramic powder with two substantially mutually soluble polymers at a temperature of 50° C. to 150° C. above the highest glass transition temperature of the polymers to achieve a uniform mixture, wherein the two polymers include a thermoplastic polymer and a thermoset epoxy resin, and the mixture comprises 50% to 75% by volume of the thermally conductive powder;
blending the uniform mixture with a curing agent at a temperature below 120° C. to obtain a melt extrudable dielectric curable material;
extruding the dielectric curable material through a slit at a temperature between 50° C. and 120° C. to form a sheet-like substrate; and
disposing separately a first film and a second film on two side surfaces of the sheet-like substrate to obtain an insulated heat conductive substrate, wherein each of the first and second films can be a metal foil or a release film.

2. The method of claim 1, wherein the organic material comprises organic silicon, and the step of performing hydrolysis and condensation of at least one thermally conductive ceramic powder is performed by reacting the organic silicon with the at least one thermally conductive ceramic powder in an acidic environment with a pH level between pH 1 and pH 5.

3. The method of claim 1, wherein the thermosetting epoxy resin is in a range of from 50 percent to 97 percent by the total volume of polymers.

4. The method of claim 1, wherein the sheet-like substrate is cured at a temperature higher than 130° C.

5. The method of claim 1, wherein the thermoplastic polymer comprises ultra-high molecular phenoxy resin.

6. The method of claim 1, wherein the thermosetting epoxy resin is an uncured liquid epoxy resin, a polymerized epoxy resin, a phenolic epoxy resin or a bisphenol A epoxy resin.

7. The method of claim 1, wherein the thermoplastic polymer comprises a hydroxy phenoxy ether polymer.

8. The method of claim 1, wherein the thermoplastic polymer is formed by reacting the liquid epoxy resin with the bisphenol A.

9. The method of claim 1, wherein the thermoplastic polymer is formed by reacting the liquid epoxy resin with a divalent acid.

10. The method of claim 1, wherein the thermoplastic polymer is formed by reacting the liquid epoxy resin with amines.

11. The method of claim 1, wherein the at least one thermally conductive ceramic powder is nitride, oxide, or a mixture thereof.

12. The method of claim 11, wherein the nitride is selected from the group consisting essentially of zirconium nitride, boron nitride, aluminum nitride, and silicon nitride.

13. The method of claim 11, wherein the oxide is selected from the group consisting essentially of aluminum oxide, magnesium oxide, zinc oxide, and titanium dioxide.

14. The method of claim 1, wherein the metal foil is selected from the group consisting of copper, aluminum, nickel, copper alloy, aluminum alloy, nickel alloy, copper nickel alloy, and copper aluminum alloy.

15. A method for manufacturing an insulated heat conductive composite substrate, comprising steps of:
performing hydrolysis and condensation of at least one thermally conductive ceramic powder to prepare at least one modified thermally conductive ceramic powder with thermal conductivity greater than 20 W/mK, which comprises a plurality of modified powder particles each grafted with an organic material;
mixing the at least one modified thermally conductive ceramic powder with two substantially mutually soluble polymers at a temperature of 50° C. to 150° C. above the highest glass transition temperature of the polymers to achieve a uniform mixture, wherein the two polymers include a thermoplastic polymer and a thermoset epoxy resin, and the mixture comprises 50% to 75% by volume of the thermally conductive powder;
blending the uniform mixture with a curing agent at a temperature below 120° C. to obtain a melt extrudable dielectric curable material;
extruding the dielectric curable material through a slit at a temperature between 50° C. and 120° C. to form a curable sheet-like substrate;
disposing separately a first film and a second film on two side surfaces of the sheet-like substrate, wherein each of the first and second films can be a metal foil or a release film;
cutting a combination of the sheet-like substrate, the first film, and the second film to obtain an insulated heat conductive substrate; and
pressing a plurality of the insulated heat conductive substrates at an elevated temperature ranging from 130° C. to 250° C. to obtain a cross-linked insulated heat conductive composite substrate.

16. The method of claim 15, wherein the insulated heat conductive composite substrate is a single-sided board, a double-sided board, a single-sided and two-layered board, a metal core board, or a multi-layered board.

17. The method of claim 15, further comprising a step of shaping the pressed insulated heat conductive substrates using a contouring process.

18. The method of claim 17, wherein the contouring process is a trimming process, a cutting process, a punching process, or a diamond cutting process.
